(19) United States
(12) Patent Application Publication
(10) Pub. No.: US 2017/0213567 A1
(43) Pub. Date: Jul. 27, 2017

(54) NOISE SUPPRESSION SYSTEM AND METHOD

(71) Applicants: Koninklijke KPN N.V., The Hague (NL); Nederlandse Organisatie Voor Toegepast-Natuurwetenschappelijk Onderzoek TNO, s-Gravenhage (NL)

(72) Inventors: Hans Maarten STOKKING, Wateringen (NL); Omar Aziz Niamut, Vlaardingen (NL); Emmanuel Thomas, Delft (NL)

(73) Assignees: Koninklijke KPN N.V., The Hague (NL); Nederlandse Organisatie Voor Toegepast- Natuurwetenschappelijk Onderzoek TNO, s-Gravenhage (NL)

(21) Appl. No.: 15/329,130

(22) PCT Filed: Jul. 30, 2015
(86) PCT No.: PCT/EP2015/067548

§ 371 Date: Jan. 25, 2017

(30) Foreign Application Priority Data
Jul. 31, 2014 (EP) 14179360.4

(51) Int. Cl. G10L 21/0208; G10L 21/0308; G10L 21/0224

(52) U.S. Cl. CPC G10L 21/0208; G10L 21/0224; G10L 21/0308; G10L 2021/02163

(57) ABSTRACT

A play-out device is provided for playing out an audio signal via a speaker to provide a sound signal, and a recording device for recording the sound signal to obtain a recorded signal comprising a recording of at least the sound signal. The play-out device is configured for generating noise suppression data comprising the audio signal, or a reference thereto, and timing information for enabling the audio signal to be correlated in time with the recorded signal. A noise suppression subsystem is provided with the recorded signal and the noise suppression data. The noise suppression subsystem comprises a timing manager for synchronizing the audio signal with the recorded signal based on the timing information, and a noise suppressor for processing the recorded signal based on said synchronized audio signal to obtain a processed signal in which the recording of the sound signal is suppressed. The noise suppression subsystem is thus enabled to perform noise suppression, even when not comprised in the play-out device but rather in another device such as the recording device.

### FIELD OF THE INVENTION

The invention relates to a system and method for noise suppression. The invention further relates to a communication system comprising the system, to a play-out device and a recording device for use in the system, to noise suppression data as generated by the play-out device, and to a computer program product comprising instructions for causing a processing system to perform the method.

### BACKGROUND ART

An audio recording obtained by a recording device may comprise undesired audio components. In particular, the audio recording may comprise a recording of a sound signal generated by a play-out device which is located in a vicinity of the recording device. The recording of the sound signal may represent an undesired audio component in that it may not be desired to record the sound signal but rather, e.g., another sound signal, or no sound at all. For example, when recording speech of a user, the sound signal generated by a television or radio playing in the background may be recorded as well. In this example, it may be desired to record the speech of the user rather than the sound signal generated by the television or radio.

To suppress undesired audio components such as background noise in a recorded signal, various techniques may be used. Such techniques are commonly referred to as (background) noise cancellation or (background) noise suppression. In the specific case that the undesired audio component is an echo, the techniques are also referred to as acoustic echo cancellation, or in short, echo cancellation.

For example, a publication titled “An Acoustic Front-End for Interactive TV Incorporating Multichannel Acoustic Echo Cancellation and Blind Signal Extraction” by Reindl et al., Conf. Record of the 44^{th} Asilomar Conference, 2010, pp. 1716-1720, attempts to compensate for impairments of a desired speech signal which may result from interfering speakers, ambient noise, reverberation, and acoustic echoes from TV loudspeakers. For that purpose, two microphone signals are used which are fed into a Multi-Channel Acoustic Echo Cancellation (MC-AEC) unit that compensates for the acoustic coupling between the loudspeakers and the microphones. The output signals of the MC-AEC are then fed into a two-channel Blind Signal Extraction (BSE) unit which extracts the desired speech signal components from the output signals.

### SUMMARY OF THE INVENTION

Disadvantageously, the system of Reindl et al. requires two microphone signals. Another disadvantage may be that the system may not be able to sufficiently separate the desired speech signal components from the background noise.

It would be advantageous to obtain a system or method for noise suppression which improves upon one or more aspects of the system of Reindl et al.

The following aspects of the invention involve a noise suppression subsystem being provided with a recorded signal comprising an undesired audio component in the form of a recording of a sound signal, the sound signal having been generated by a play-out device playing out an audio signal. To enable the noise suppression subsystem to suppress the sound signal, the play-out device may provide noise suppression data to the noise suppression subsystem to enable the audio signal to be accessed and to be correlated in time with the recorded signal.

A first aspect of the invention provides a system for noise suppression, wherein the system may comprise:
a play-out device for playing out an audio signal via a speaker to provide a sound signal;
a recording device for recording the sound signal to obtain a recorded signal comprising a recording of at least the sound signal,

wherein the play-out device may be configured for providing noise suppression data to a communication channel,

wherein the noise suppression data may comprise:

i) the audio signal, or a reference to the audio signal which enables the audio signal to be accessed; and

ii) timing information for enabling the audio signal to be correlated in time with the recorded signal;

wherein the system may further comprise a noise suppression subsystem configured for obtaining the recorded signal and the noise suppression data,

and wherein the noise suppression subsystem may comprise:
a timing manager for synchronizing the audio signal with the recorded signal based on the timing information to obtain a synchronized audio signal; and
a noise suppressor for processing the recorded signal based on the synchronized audio signal to obtain a processed signal in which the recording of the sound signal is suppressed.

Further aspects of the invention provide, respectively, a recording device as used in the system, a play-out device as used in the system, and noise suppression data as generated by the play-out device.

A further aspect of the invention provides a method for suppressing noise, wherein the method may comprise:
obtaining a recorded signal comprising a recording of at least a sound signal, the sound signal being provided by a play-out device playing out an audio signal via a speaker;
obtaining, via a communication channel, noise suppression data from the play-out device, the noise suppression data comprising:

i) the audio signal, or a reference to the audio signal which enables the audio signal to be accessed; and

ii) timing information for enabling the audio signal to be correlated in time with the recorded signal;
synchronizing the audio signal with the recorded signal based on the timing information to obtain a synchronized audio signal; and
processing the recorded signal based on the synchronized audio signal to obtain a processed signal in which the recording of the sound signal is suppressed.

A further aspect of the invention provides a computer program product comprising instructions for causing a processing system to perform the method.

Embodiments are defined in the dependent claims.

In accordance with the above, a play-out device may be provided which may play out an audio signal via a speaker to provide a sound signal. Here, the term ‘sound signal’ refers to an audible signal, and the term ‘audio signal’ refers to an electronic representation of such a sound signal. As such, the play-out device may render, present or reproduce the audio signal in audible form. In addition, a recording device may be provided which may record at least the sound signal to obtain a recorded signal. As such, the recording device may obtain an electronic representation of the sound signal. The recorded signal comprises ‘at least’ the recording of the sound signal in that it may, or may not, comprise recordings of other sound signals. In the former case, the sound signal may be combined with the other sound signals in the recorded signal, yielding a recorded signal capturing several sound signals.

The play-out device may be configured for generating and externally outputting noise suppression data. The noise suppression data may comprise the audio signal itself, or a reference to the audio signal which enables the audio signal to be accessed. In the former case, the audio signal may be included in the noise suppression data in compressed form, but may not need to be. In case of a reference, the reference may refer to a resource from which the audio signal may be accessed. The noise suppression data may additionally comprise timing information for enabling the audio signal to be correlated in time with the recorded signal. Here, the term ‘correlated in time’ refers to the relation in time between both signals having been determined, or at least to an approximate degree, thereby enabling the recording of the sound signal to be aligned in time with the audio signal from which it originated.

The noise suppression subsystem may be provided with the recorded signal and the noise suppression data. The recorded signal may have been obtained directly or indirectly from the recording device. Alternatively, in case the noise suppression subsystem is comprised in the recording device, the recorded signal may have been obtained from within the recording device. Moreover, the noise suppression data may have been obtained directly or indirectly from the play-out device. It is noted that the recorded signal and/or the noise suppression data may be, but do not need to be, provided to the noise suppression subsystem via one or more intermediary devices and/or subsystems. In order to obtain the noise suppression data from the play-out device, use is made of a communication channel. The communication channel may be a wired or wireless communication channel, or a combination thereof. The communication channel may be part of a network.

The noise suppression subsystem may comprise a timing manager for synchronizing the audio signal with the recorded signal based on the timing information. For example, such synchronization may comprise altering timestamps of the audio signal and/or the recorded signal, or generating synchronization data representing a time difference between the audio signal and the recorded signal. Here, the term ‘synchronizing’ refers to a synchronization to a degree which is deemed suitable for subsequent noise suppression, being typically in the milliseconds range. The noise suppression subsystem may further comprise a noise suppressor for processing the recorded signal based on said synchronized audio signal to obtain a processed signal in which the recording of the sound signal is suppressed. For example, the synchronized audio signal may be subtracted from the recorded signal.

The above measures may have the advantageous technical effect that a noise suppression subsystem is provided which may suppress a recording of a sound signal in a recorded signal despite the noise suppression subsystem not being part of the play-out device. Namely, by providing noise suppression data from the play-out device via a communication channel to the noise suppression subsystem, the noise suppression subsystem is enabled to access the audio signal, and to correlate it in time with the recorded signal. As such, the noise suppression subsystem may use the data to suppress the recording of the sound signal in the recorded signal. An advantage of the above may be that noise suppression can be performed in cases where the noise suppression subsystem is not comprised in the play-out device but rather in, e.g., a recording device separate from the play-out device, or in another device.

The inventors have recognized that the above noise suppression is well suited in cases where a recording device is provided as part of a communication system, e.g., as part of a first communication device which records speech of a first user for transmission to a second communication device of a second user, but where a play-out device is playing out an audio signal in the background causing the recording of the speech to be disturbed by the played-out audio signal. By providing noise suppression data as claimed from the play-out device to a noise suppression subsystem of the communication system, such background noise can be suppressed within the communication system, e.g., before or after transmission of the recorded signal to the second communication device of the second user.

In an embodiment, the audio signal obtained by the noise suppression subsystem may comprise one or more content timestamps, and the timing manager may be configured for synchronizing the audio signal with the recorded signal further based on the one or more content timestamps. By providing content timestamps as part of the audio signal, the audio signal is provided with time reference information. Accordingly, the timing information provided by the play-out device as part of the noise suppression data may refer to, or be constituted in part by, the content timestamps to enable the audio signal to be correlated in time with the recorded signal.

In an embodiment, the audio signal played-out by the play-out device may comprise one or more watermarks, the one or more watermarks may be associated with one or more watermark timestamps having a known relation in time with the one or more content timestamps, the noise suppression subsystem may comprise a watermark detector for detecting the one or more watermarks in the recorded signal, and the timing manager may be configured for synchronizing the audio signal with the recorded signal by correlating the one or more watermark timestamps in time with the one or more content timestamps. A watermark is a form of persistent identification. By providing watermarks as part of the played-out audio signal and by providing the noise suppression subsystem with a watermark detector, the noise suppression subsystem may detect the watermarks in the recorded signal. As such, the watermark timestamps associated with the watermarks may be identified. The watermark timestamps may have a known relation in time with the one or more content timestamps. Here, ‘known relation in time’ refers to the watermark timestamps representing same or similar time instances as the content timestamps, or having a difference which is—or has been made—known to the noise suppression subsystem. Accordingly, by correlating the watermark timestamps with the content timestamps, the audio signal may be synchronized with the recorded signal.

In an embodiment, the one or more watermark timestamps may be play-out timestamps of the one or more watermarks at the play-out device, and the timing information provided by the play-out device may be constituted at least in part by the one or more play-out timestamps. By providing the play-out timestamps of the watermarks to the noise suppression subsystem as part of the timing information, the noise suppression subsystem may be provided with both the watermarks, e.g., as detected in the recorded signal, and the associated watermark timestamps. Accordingly, the noise suppression subsystem may use the noise suppression data to suppress the recording of the sound signal in the recorded signal.

In an embodiment, the one or more watermark timestamps may be encoded in respective ones of the one or more watermarks. By encoding the watermark timestamps in the watermarks, it is not needed to provide them separately to the noise suppression subsystem, e.g., as part of the timing information. An advantage of this embodiment may be that it may not be needed to separately provide timing information to the noise suppression subsystem. Rather, the timing information may be constituted in part by the content timestamps of the audio signal, as provided by the noise suppression data, and in part by the watermarks of the recorded signal.

In an embodiment, the play-out device may comprise a clock, the timing information provided by the play-out device may comprise one or more play-out timestamps associated with one or more content timestamps of the audio signal, the one or more play-out timestamps may be derived from the clock during play-out of the audio signal, the recording device may comprise a further clock having a known relation in time with the clock of the play-out device, the recording device may derive one or more recording timestamps from the further clock during recording of the sound signal, and the timing manager may be configured for synchronizing the audio signal with the recorded signal by correlating the one or more recording timestamps in time with the one or more content timestamps of the audio signal using the one or more play-out timestamps. By providing the play-out device and the recording device with clocks which have a known relation in time, e.g., by being synchronized or having a difference which is—or has been made—known to the timing manager, the recording timestamps can be related in time with the play-out timestamps. By providing the play-out timestamps associated with one or more content timestamps as part of the timing information to the noise suppression subsystem, the noise suppression subsystem may use the noise suppression data to suppress the recording of the sound signal in the recorded signal. It is noted that the content timestamps may be associated with the play-out timestamps in various ways, e.g., by the content timestamps being provided together with the play-out timestamps as the timing information, by the play-out timestamps being linked to content timestamps in the audio signal, etc. Accordingly, the recording timestamps of the recorded signal may be matched to the content timestamps of the audio signal by matching them to the play-out timestamps and thereby to the associated content timestamps. An advantage of this embodiment may be that no special processing of the audio signal is needed, such as watermarking.

In an embodiment, the audio signal obtained by the noise suppression subsystem may comprise one or more watermarks matching one or more watermarks in the recorded signal, the noise suppression subsystem may comprise a watermark detector for detecting the one or more watermarks in the audio signal and in the recorded signal, and the timing manager may be configured for synchronizing the audio signal with the recorded signal by aligning in time the one or more watermarks in the audio signal and in the recorded signal. Accordingly, use is made of a watermark being a persistent identification and thereby being identifiable from the audio signal as well as from a recording of the played-out audio signal. An advantage of this embodiment may be that it may not be needed to separately provide timing information to the noise suppression subsystem. Rather, the timing information may be constituted in part by the watermarks embedded in the audio signal, as provided by the noise suppression data, and in part by the watermarks embedded in the recorded signal.

In an embodiment, the recorded signal may comprise, in addition to the recording of the sound signal, a recording of a further sound signal, and the noise suppressor may process the recorded signal to obtain the processed signal having the recording of the sound signal suppressed with respect to the recording of the further sound signal. The system may be advantageously used to suppress the recording of the sound signal in the recorded signal so as to make the further sound signal more discernable. For example, the further sound signal may be constituted by speech of a user. Accordingly, the speech of the user may be made more discernable.

In an embodiment, the recording device may comprise the noise suppression subsystem. Accordingly, the recording device may be enabled to suppress the sound signal during or after recording.

In an embodiment, a communication system may be provided for enabling speech communication between users, wherein the communication system may comprise at least one instance of the recording device. For example, the recording device may be comprised in, or constituted by, a communication device which records speech of a first user for transmission to a communication device of a second user.

In an embodiment, the play-out device may comprise at least one of:
a watermark inserter for inserting one or more watermarks in the audio signal prior to play-out and/or transmission via the communication channel to the recording device; and
a timestamp function unit for determining one or more play-out timestamps during play-out of the audio signal for use in the timing information.

In summary, a play-out device may be provided for playing out an audio signal via a speaker to provide a sound signal, and a recording device may be provided for recording the sound signal to obtain a recorded signal comprising a recording of at least the sound signal. The play-out device may be configured for generating noise suppression data comprising the audio signal, or a reference thereto, and timing information for enabling the audio signal to be correlated in time with the recorded signal. A noise suppression subsystem may be provided with the recorded signal and the noise suppression data. The noise suppression subsystem may comprise a timing manager for synchronizing the audio signal with the recorded signal based on the timing information, and a noise suppressor for processing the recorded signal based on said synchronized audio signal to obtain a processed signal in which the recording of the sound signal is suppressed. The noise suppression subsystem may thus be enabled to perform noise suppression, even when not comprised in the play-out device but rather in another device such as the recording device.

It will be appreciated by those skilled in the art that two or more of the above-mentioned embodiments, implementations, and/or aspects of the invention may be combined in any way deemed useful.

Modifications and variations of the play-out device, the recording device, the noise suppression data, the method, and/or the computer program product, which correspond to the described modifications and variations of the system, can be carried out by a person skilled in the art on the basis of the present description.

The invention is defined in the independent claims. Advantageous yet optional embodiments are defined in the dependent claims.

### BRIEF DESCRIPTION OF THE DRAWINGS

These and other aspects of the invention are apparent from and will be elucidated with reference to the embodiments described hereinafter. In the drawings,

FIG. 1 shows a system for noise suppression, the system comprising a play-out device and a recording device, the recording device comprising a noise suppression subsystem, and the play-out device providing noise suppression data to the noise suppression subsystem via a communication channel;

FIGS. 2A-2D relate to different configurations of the system, in that they schematically illustrate different forms of timing information being provided from the play-out device to the recording device, wherein

FIG. 2A shows the audio signal provided to the recording device comprising one or more content timestamps, the play-out device and the recording device comprising a clock, and the clocks having a known relation in time;

FIG. 2B shows the audio signal provided to the recording device comprising one or more watermarks matching one or more watermarks in the recorded signal;

FIG. 2C shows the audio signal provided to the recording device comprising one or more content timestamps, the audio signal played-out by the play-out device comprising one or more watermarks, and play-out timestamps of the one or more watermarks at the play-out device being provided to the recording device;

FIG. 2D is similar to FIG. 2C except that here the play-out timestamps are encoded in respective ones of the one or more watermarks;

FIG. 2E shows a legend for FIGS. 2A-2D;

FIG. 3 shows various components of the play-out device, including a watermark inserter and a timestamp function unit;

FIG. 4 shows various components of the recording device, including a timing manager and a noise suppressor;

FIG. 5 shows noise suppression data as generated by the play-out device;

FIG. 6 shows a method for noise suppression; and

FIG. 7 shows a computer program product comprising instructions for causing a processing system to perform the method.

It should be noted that items which have the same reference numbers in different Figures, have the same structural features and the same functions, or are the same signals. Where the function and/or structure of such an item has been explained, there is no necessity for repeated explanation thereof in the detailed description.

### LIST OF REFERENCE NUMERALS

The following list of reference numbers is provided for facilitating the interpretation of the drawings and shall not be construed as limiting the claims.

020 communication channel

040 sound signal

060 providing of timing information via communication channel

080 providing of audio signal via communication channel

100 system for noise suppression

120 speaker

140 microphone

200 play-out device

210 output interface

220 clock

250 watermark inserter

252 combination of watermark inserter and timestamp function unit

260 timestamp function unit

270 decoder

280 encoder

290 audio buffer

300 recording device

310 input interface

320 clock

330 timing manager

340 noise suppressor

342 impulse response estimator

350 watermark detector

352 combination of watermark detector and timestamp extractor

360 timestamp extractor

370 decoder

380 recording buffer

390 audio buffer

400 noise suppression data

410 audio signal

412 audio signal or reference

420 timing information

430 watermark

440 watermark encoding timestamp

460 recorded signal

470 synchronized audio signal

480 processed signal

500 method for noise suppression

510 obtaining recorded signal

520 obtaining noise suppression data

530 synchronizing audio signal using noise suppression data

540 processing recorded signal using synchronized audio signal

600 computer readable medium

610 computer program stored as non-transitory data

### DETAILED DESCRIPTION OF EMBODIMENTS

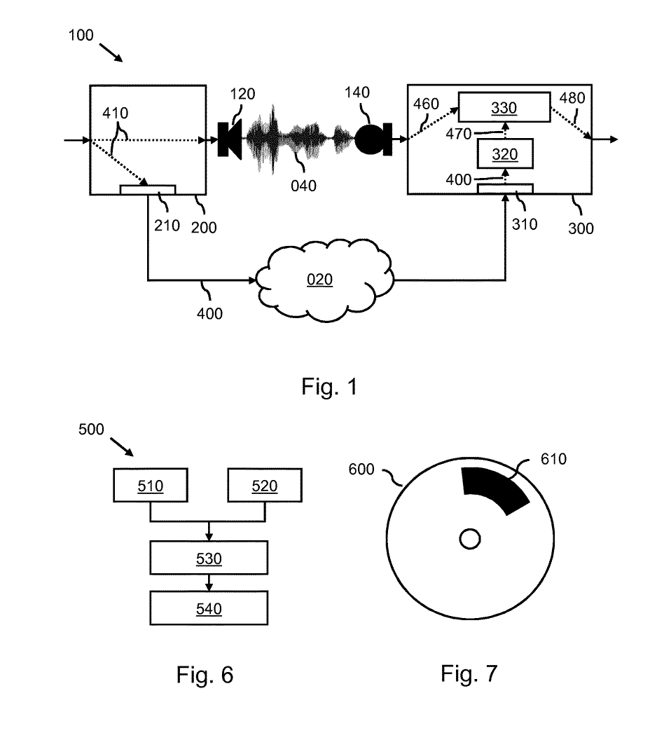

FIG. 1 shows a system 100 for noise suppression. The system 100 comprises a play-out device 200 for playing out an audio signal 410 via a speaker 120 to provide a sound signal 040, and a recording device 300 for recording the sound signal 040 to obtain a recorded signal 460 comprising a recording of at least the sound signal. For that purpose, the recording device 300 is shown to be connected to a microphone 140, with the microphone converting sound waves of the sound signal 040 into an electric signal. Although not explicitly shown in FIG. 1, the play-out device 200 and the recording device 300 may be co-located, e.g., located in a same room or location. However, this is not a limitation, in that it may rather be the speaker 120 and the microphone 140 which are co-located, or at least arranged at a mutual distance in which the microphone 140 still registers sound waves of the sound signal 040.

FIG. 1 further shows a communication channel 020 enabling data communication between the play-out device 200 and the recording device 300. The communication channel 020 may take any suitable form, and may comprise wireless and/or wired portions. Suitable forms of communication include, e.g., Wi-Fi, Bluetooth, ZigBee, Ethernet, etc. The data communication via the communication channel 020 may be Internet Protocol (IP) based, or in general, network-based.

The play-out device 200 may be configured for providing, via the communication channel 020, noise suppression data 400 to the recording device 300. For that purpose, the play-out device 200 is shown to comprise an output interface 210 for outputting data to the communication channel 020, and the recording device 300 is shown to comprise an input interface 310 for receiving data from the communication channel 020. Each respective interface may take any suitable form. For example, for providing Bluetooth-based data communication, the output interface may be a Bluetooth transmitter and the input interface may be a Bluetooth receiver.

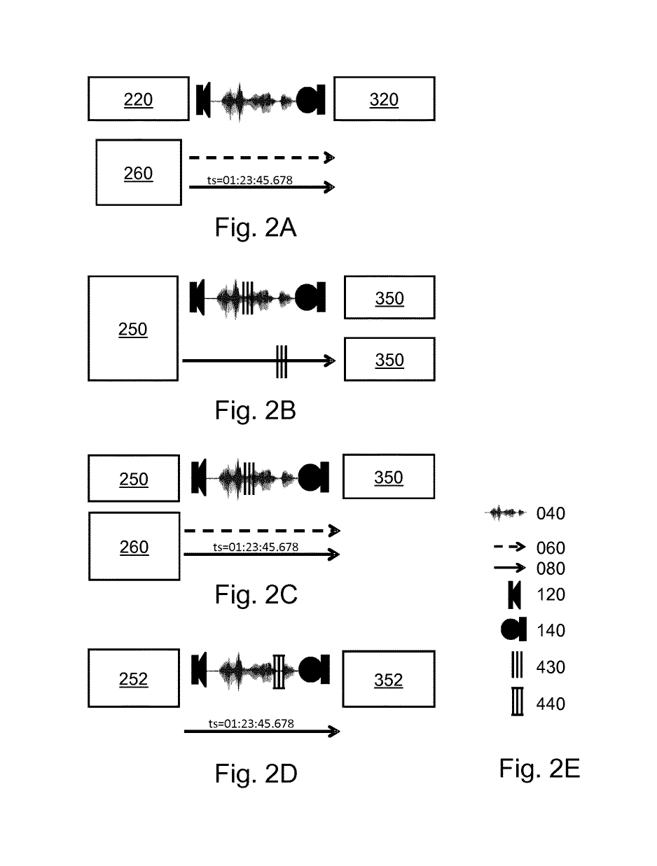

The noise suppression data 400 generated by play-out device 200 may comprise the audio signal. Alternatively, although not shown in FIG. 1, the noise suppression data 400 may comprise a reference to the audio signal which enables the audio signal to be accessed. In addition, the noise suppression data 400 may comprise timing information for enabling the audio signal to be correlated in time with the recorded signal. It is noted that the format and function of the noise suppression data 400 will be further elucidated with reference to FIGS. 2A-2E and FIG. 5.

FIG. 1 further shows the recording device 300 comprising a timing manager 320 for synchronizing the audio signal with the recorded signal based on the timing information. For that purpose, the timing manager 320 is shown to receive the noise suppression data 400 from the input interface 310. The recording device 300 may further comprise a noise suppressor 330 for processing the recorded signal 460 based on said synchronized audio signal to obtain a processed signal 480 in which the recording of the sound signal is suppressed. For that purpose, the noise suppressor 330 is shown to receive the recorded signal 460 from within the recording device 300 and the synchronized audio signal 470 from the timing manager, and to output the processed signal 480, e.g., for further transmission, processing, storage, etc.

The system may be advantageously used in use-cases where the recorded signal comprises, in addition to the recording of the sound signal, a recording of a further sound signal. As such, the noise suppressor may provide a processed signal in which the recording of the sound signal is suppressed with respect to the recording of the further sound signal. For example, in case the further sound signal is constituted by speech of a user, the sound signal of the play-out device may be suppressed with respect to the speech of the user, thereby improving the intelligibility of the speech.

Examples of advantageous use-cases include the following:
Social television (TV). Here, two or more parties may view the same TV program at different locations and at the same time communicate with each other via an audio communication channel. In this use case, each respective party may hear the TV audio of the other party through the audio communication channel in addition to the TV audio of their own TV. Moreover, even if the TV audio at each location is synchronized, the transmission delay of the audio communication channel will delay the TV audio, causing annoying echoes, and will not help in correctly hearing the other party. In addition, the TV's audio volume might be loud, further reducing intelligibility. The system may be employed here to suppress the TV audio in the recorded signal at one, or more parties, prior to transmitting the recorded signal to another party.
Speech control. If a user is trying to control an electronic device using his/her speech, background noise such as TV audio may severely limit the usability of speech control. The system may be employed here to suppress the TV audio in the recorded signal prior to applying speech recognition to the recorded signal.
Forensic audio enhancement. Here, law enforcement may attempt to listen in on a target using audio surveillance, while the target may attempt to hinder such eavesdropping by turning the volume of a play-out device, such as a home or car stereo, very high. Here, the system may be employed to suppress the sound signal of the play-out device in the recorded signal obtained by law enforcement.
Audio communication. In general, in audio communication, it may be desirable to avoid transmitting the sound signal of a TV or radio playing in the background in order to avoid letting the other party know which TV program you are watching or what radio station you are listening to, e.g., for reasons of privacy. The system may be employed here to suppress such sound signals in the recorded signal at one, or both parties, prior to transmitting the recorded signal to the other party.
Audio recording. It may be desirable to record your own speech on some recording device, e.g. for taking personal notes, without recording background audio. Likewise, the system may be employed to suppress background noise.
Referring further to FIG. 1, it is noted that the timing manager 320 and the noise suppressor 330 may together form at least part of a noise suppression subsystem. As such, FIG. 1 shows the recording device 300 comprising this noise suppression subsystem, with this being also case in the examples of FIG. 2A-D, 4. However, this is not a limitation, in that the noise suppression subsystem may also be located outside, i.e., externally, of the recording device, e.g., in another device, distributed in functionality across a plurality of devices, etc. Accordingly, the noise suppression subsystem may receive the recorded signal 460 from the recording device 300 and the noise suppression data 400 from the play-out device. The latter may be, but does not need to be, received via the recording device 300.

It is further noted that the synchronization of the audio signal with the recorded signal may be a coarse synchronization in that there may, after synchronization, still be a delay remaining between the synchronized audio signal and the recorded signal. A reason for this may be that the system may not always be able to account for all factors contributing to the delay between the audio signal and the recorded signal. For example, there is normally a propagation delay of the sound signal from the speaker of the play-out device to the microphone of the recording device. For certain configurations of the system, as elucidated further from FIGS. 2A onward, such a delay may need to be known in order to perfectly synchronize the audio signal with the recorded signal. However, even in cases where the system is unable to account for such delay factors, the timing manager may nevertheless synchronize the audio signal to the recording signal to a degree which is suitable for subsequent noise suppression.

In this respect, it is noted that noise suppression techniques are known, and may be used by the noise suppressor, which are capable of compensating for ‘smaller’ delays between input signals, e.g., up to 128 ms. An example of such a technique is noise suppression using adaptive filters. However, in view of the coarse synchronization performed by the timing manager, such noise suppression techniques may be simpler, e.g., by using shorter adaptive filters, requiring fewer iterations, etc.

FIGS. 2A-2D relate to different configurations of the system, in that they schematically illustrate different forms of timing information being provided from the play-out device to the recording device. Throughout FIGS. 2A-2D, the left-hand side of each Fig. represents the play-out device whereas the right-hand side represents the recording device. In each case, the transmission of the sound signal 040 is shown, as well as further signaling from the play-out device to the recording device via the communication channel. FIG. 2E represents a legend for each of FIGS. 2A-2D.

FIG. 2A relates to the following. The audio signal 080 provided to the recording device may comprise one or more content timestamps. As depicted in the example of FIG. 2A, a content timestamp may have a value such as 01:23:45.678 [hh:mm:ss.sss]. The one or more content timestamps may have been inserted into the audio signal 080 by the play-out device, or may have already been present therein. The play-out device may comprise a clock 220. The recording device may also comprise a clock 320 having a known relation in time with the clock 220 of the play-out device. For example, both clocks 220, 320 may be synchronized. The synchronization may be network-based, and may make use of a protocol such as the Precision Time Protocol (PTP). Alternatively, the clocks 220, 320 may have a difference, such as an offset, which has been made known to the timing manager. Such making known of the difference, e.g., via a network, may represent an implicit synchronization rather than an explicit synchronization. The play-out device may further comprise a timestamp function unit 260 which determines one or more play-out timestamps during play-out of the audio signal. The one or more play-out timestamps may be derived from the clock 220. Moreover, associated content timestamps may be derived which may denote the part of the content, e.g., the audio signal, being played-out. The one or more play-out timestamps and associated content timestamps may be provided to the recording device as timing information 060. Alternatively, the timing information 060 may comprise play-out timestamps linked to content timestamps included in the audio signal. Moreover, at the recording device, one or more recording timestamps may be derived from the further clock 320 during recording of the sound signal.

The timing manager may then synchronize the audio signal with the recorded signal by correlating in time one or more content timestamps of the audio signal with the one or more recording timestamps. For that purpose, the timing manager may match the recording timestamps of the recorded signal to the play-out timestamps of the audio signal and thereby to the associated content timestamps. As such, the audio signal may be synchronized with the recorded signal so as to obtain a synchronized audio signal. It is noted that the matching of the recording timestamps to the play-out timestamps may be a ‘one-to-one’ matching which may assume no delay existing between the play-out and subsequent recording of the sound signal.

In practice, however, there may be a delay constituted at least in part by a propagation time of the sound signal from the speaker to the microphone. By disregarding such a delay, the synchronization may effectively be a coarse synchronization, as previously discussed, thereby yielding a coarsely synchronized audio signal. The timing manager may also compensate for such delay, e.g., by assuming a predefined delay value or by estimating the delay, e.g., by applying a cross-correlation technique to the coarsely synchronized audio signal and the recorded signal to determine the delay.

FIG. 2B relates to the following. The audio signal 080 obtained by the noise suppression subsystem may comprise one or more watermarks matching one or more watermarks in the recorded signal. For example, such watermarks 430 may be inserted by a watermark inserter 250 into the audio signal prior to play-out and prior to transmission via the communication channel. Due to their persistent nature, such watermarks 430 may remain embedded in the sound signal 040 and detectable after recording. The noise suppression subsystem may comprise a watermark detector 350 for detecting the one or more watermarks in the audio signal and the corresponding watermarks in the recorded signal. Having detected the watermarks 430 in both signals, the timing manager may synchronize the audio signal with the recorded signal by aligning in time the one or more watermarks in the audio signal and in the recorded signal. It is noted that in this example, the timing information is constituted at least in part by the watermarks embedded in the audio signal 080. As such, it may not be needed to separately provide timing information to the noise suppression subsystem.

FIG. 2C relates to the following. The audio signal 080 obtained by the noise suppression subsystem may comprise one or more content timestamps. At the same time, the audio signal played-out by the play-out device, and therefore the sound signal 040, may comprise one or more watermarks 430. For example, such watermarks 430 may be inserted by a watermark inserter 250 into the audio signal during or prior to play-out. The one or more watermarks 430 may be associated with one or more watermark timestamps which have a known relation in time with the one or more content timestamps. In this example, the watermark timestamps may be constituted by play-out timestamps of the one or more watermarks at the play-out device, which may be generated by a timestamp function unit 260 of the play-out device and subsequently provided to the recording device as timing information 060. The noise suppression subsystem at the recording device may comprise a watermark detector 350 for detecting the one or more watermarks 430 in the recorded signal. The timing manager may then synchronize the audio signal with the recorded signal by correlating the one or more play-out timestamps in time with the one or more recording timestamps. As such, the audio signal may be synchronized with the recorded signal so as to obtain a synchronized audio signal.

FIG. 2D is similar to FIG. 2C except that here the play-out timestamps of the watermarks are encoded in respective ones of the one or more watermarks instead of being signaled separately via the communication channel. Namely, the play-out device is shown to comprise a combination 252 of watermark inserter and timestamp function unit which may insert one or more watermarks 440 into the audio signal during or prior to play-out and encode their times of presentation, i.e., play-out. Due to their persistent nature, such watermarks 440 may remain embedded in the sound signal 040 and detectable after recording. Moreover, the noise suppression subsystem may comprise a combination 352 of watermark detector and timestamp extractor for detecting the one or more watermarks in the recorded signal and decoding the one or more play-out timestamps. The timing manager may then synchronize the audio signal to the recorded signal, as previously explained with reference to FIG. 2C.

It is noted that in the above examples of FIGS. 2B-2D, it may in principle suffice for the play-out device to provide a single watermark during the course of play-out. However, the watermark detector may miss detection of a watermark, e.g., due to distortions, interference of other sound signals, etc. Accordingly, the play-out device may provide more than one watermark, e.g., at regular or irregular intervals. Such watermarks may differ, thereby enabling the watermark detector to uniquely match respective a watermark in the recorded signal to a watermark in the audio signal and/or to a watermark timestamp. Here, reference is made to WO 2013/144347, and in particular to its description of the use of watermark-based markers. It is noted that any suitable watermarking technique may be used, as known per se from the field of watermarking. A non-limiting example is spread spectrum audio watermarking.

It is further noted that the term ‘play-out timestamp’ may refer to a timestamp representing the actual time, e.g., in relation to a wall clock, at which the play-out device is presenting. Moreover, the term ‘content timestamp’ may refer to a timestamp marking a specific point in the content, e.g., the audio signal. An example of a content timestamp is a presentation timestamp included in an MPEG transport stream (TS) for the purpose of synchronizing different elementary streams.

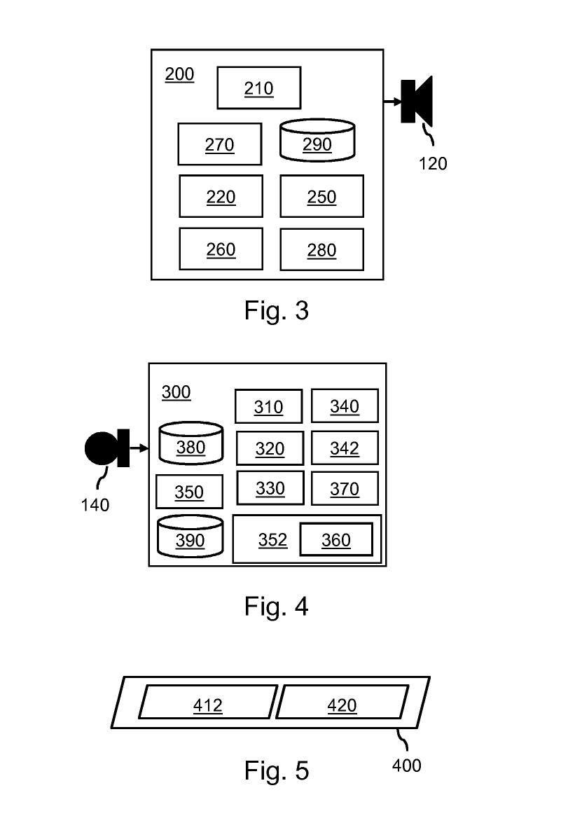

FIG. 3 shows various components of a play-out device 200. It is noted that, depending on the configuration of the system in which the play-out device is used, the play-out device may comprise only a subset of the components shown in FIG. 3. Furthermore, to avoid unnecessary complexity, FIG. 3 omits the internal data communication within the play-out device, e.g., between the various components.

In general, the play-out device 200 may comprise an output interface 210 for outputting the noise suppression data to the communication channel. The play-out device 200 may comprise a clock 220. The clock 220 may be, but does not need to be, synchronized or have a known relation in time with a clock in the recording device. The play-out device 200 may comprise a watermark inserter 250 which may insert one or watermarks into the audio signal during or prior to play-out and/or prior to transmission via the communication channel. The play-out device 200 may comprise a timestamp function unit 260 which may determine one or more play-out timestamps. The play-out timestamps may be of watermarks. The timestamp function unit 260 may make use of the clock 220 in determining the play-out timestamps. The timestamp function unit 260 may cooperate with the watermark inserter, e.g., by being integrated therein, to allow the play-out timestamps to be encoded in respective watermarks. The play-out device 200 may comprise a decoder 270. The decoder 270 may be used to decode the audio signal from a received audio stream. The play-out device 200 may comprise an encoder 280. The encoder 280 may be used to encode the audio signal prior to transmission via the communication channel. Such encoding may comprise lossless or lossy compression. The play-out device 200 may comprise an audio buffer 290. The audio buffer 290 may be used to delay the play-out of the audio signal to pre-compensate for a transmission delay of the noise suppression data.

Although not explicitly shown in FIG. 3, the play-out device may comprise a processor for processing the audio signal prior to inclusion in the noise suppression data. Such processing may comprise, e.g., simulating the characteristics of the speaker. For example, if the play-out device knows the characteristics of the speaker, the audio signal may be processed so as to apply the characteristics of the speaker also to the audio signal. As such, noise suppression data may be obtained of which the audio signal better matches the sound signal as recorded by the recording device.

FIG. 4 shows various components of a recording device 300. Like the play-out device shown in FIG. 3, the recording device 300 may in certain configurations only comprise a subset of the components shown in FIG. 4. Also, to avoid unnecessary complexity, FIG. 4 omits the internal data communication within the recording device.

In general, the recording device 300 may comprise an input interface 310 for receiving the noise suppression data from the communication channel. The recording device 300 may comprise a clock 320. The clock 320 may be, but does not need to be, synchronized or have a known relation in time with a clock in the play-out device. The recording device 300 may comprise a timing manager 330 for synchronizing the audio signal with the recorded signal based on timing information. The recording device 300 may comprise a noise suppressor 340 for processing the recorded signal based on the synchronized audio signal to obtain a processed signal in which the recording of the sound signal is suppressed. Together, the timing manager 330 and the noise suppressor 340 may form (part of) a noise suppression subsystem.

The recording device 300 may comprise an impulse response estimator 342. The impulse response estimator 342 may estimate an impulse response of the speaker, the room and the microphone from the recorded signal. The impulse response may be applied to the (synchronized) audio signal prior to being subtracted from the recorded signal. As such, it may be possible to compensate for the sound signal being recorded no longer perfectly matching the audio signal from which the sound signal originated due to imperfect reproduction by the speaker, reverberations within the room, and imperfect recording by the microphone. The recording device 300 may comprise a watermark detector 350 which may detect one or more watermarks into the recorded signal and/or the (synchronized) audio signal. Alternatively, a combination 352 of watermark detector and timestamp extractor may be provided which may comprise a timestamp extractor 360. The timestamp extractor 360 may extract timestamps from watermarks in cases where the watermarks encode the timestamps. It is noted that the components described in this paragraph may be part of the noise suppression subsystem, also when located externally of the recording device.

The recording device 300 may comprise a decoder 370 for decoding an encoded audio signal as received via the communication channel. The recording device 300 may comprise a recording buffer 380. The recording buffer 380 may be used to buffer the recorded signal prior to noise suppression so as to account for a transmission delay of the noise suppression data. The recording device 300 may comprise an audio buffer 390. The audio buffer 390 may be used to buffer the audio signal received via the communication channel in cases where it runs ahead of the recorded signal. This may occur when the play-out device delays the play-out of the audio signal with respect to the transmission of the noise suppression data.

In general, the play-out device may take various forms, such as, but not limited to, a television, a stereo, a computer, etc. The recording device may also take various forms, such as, but not limited to, a computer, a tablet device, a mobile phone, a home phone, etc. In particular, the recording device may be comprised in, or constituted by, a communication device. The communication device may, together with another communication device and optionally a server, form a communication system which enables speech communication between users. In addition to speech communication, the communication system may, but does not need to, provide video communication. For that purpose, the communication device may comprise a camera.

FIG. 5 shows noise suppression data 400 as generated by the play-out device. The noise suppression data 400 is shown to comprise a data representation of the audio signal or a reference to the audio signal which enables the audio signal to be accessed, both being indicated in FIG. 5 by the reference numeral 412. In this respect, it is noted that throughout the description, the term ‘audio signal’ is to be understood as referring to the audio signal in digital form, i.e., to its data representation. In case the noise suppression data 400 comprises the audio signal 412, the audio signal 412 may be comprised therein in encoded form. Such encoding may comprise lossless or lossy compression. Although not shown in FIG. 5, the audio signal 412 may further comprise one or more content timestamps. The content timestamps may be included as metadata in the data presentation of the audio signal. The audio signal 400 may be formatted as an audio stream. Accordingly, the play-out device may stream the audio signal 412 via the communication channel to the noise suppression subsystem.

Alternatively, the noise suppression data may comprise a reference 412 to the audio signal from which the audio signal may be accessed. The reference 412 may be a reference to a resource. The resource may be a network resource such as a streaming server. For example, the reference may be to a stream representing a broadcast of a television channel, a stream representing a broadcast of a radio channel, or to a video-on-demand stream, etc. The content timestamps may be the timestamps originally present in the audio signal or its stream before reception by the play-out device. Watermarks may also be present in the audio signal, in which case the play-out device may make use of the watermarks. Also, in such a case, it may not be needed for the play-out device itself to insert watermarks in the audio signal.

It is noted that the audio signal accessed on the resource may comprise the same content timestamps as the audio signal available to the play-out device. For example, in case the content timestamps are constituted by presentation timestamps included in a MPEG transport stream, the play-out device and the noise suppression subsystem may have access to the same content timestamps when accessing the MPEG transport stream. Accordingly, the play-out device may directly use the content timestamps in generating the timing information. Alternatively, if the audio signal accessed by the noise suppression subsystem comprises different content timestamps than those available to the play-out device, these different content timestamps may be correlated in time using correlation information. Such correlation information is described in WO 2010/106075 A1 for purpose of media stream synchronization, and may be used to correlate the content timestamps at the play-out device to the (different) content timestamps at the noise suppression subsystem.

The noise suppression data 400 is further shown to comprise the timing information 420. The timing information 420 may comprise one or more play-out timestamps. In addition, the timing information 420 may comprise one or more content timestamps which are associated with the one or more play-out timestamps, or may comprise other information which may enable the timing manager to associate the play-out timestamps with the content timestamps of the audio signal 412. The timing information 420 may be formatted as a metadata stream. Accordingly, the play-out device may stream the timing information 420 via the communication channel. The metadata stream may be multiplexed with the audio stream to obtain a multiplexed stream such as a MPEG Transport Stream (TS). Such multiplexing may take place in cases where the audio signal 412 does not comprise content timestamps. Accordingly, the play-out timestamps or other information provided by the timing information 420 may be associated with respective parts of the audio signal 412.

In general, the noise suppression data may comprise i) an audio stream representing the audio signal, the audio stream comprising content timestamps, and ii) a metadata stream representing the timing information, the metadata stream comprising at least one combination of a play-out timestamp and a content timestamp. Alternatively, the noise suppression data may comprise i) an audio stream representing the audio signal and ii) a metadata stream representing the timing information, the metadata stream comprising at least one play-out timestamp, the metadata stream being multiplexed with the audio stream so as to associate the at least one play-out timestamp with respective part(s) of the audio signal. The audio stream may comprise a watermark, e.g., as described with reference to FIG. 2B.

FIG. 6 shows a method 500 for suppressing noise. The method 500 may comprise, in an operation titled “OBTAINING RECORDED SIGNAL”, obtaining 510 a recorded signal comprising a recording of at least a sound signal, the sound signal being provided by a play-out device playing out an audio signal via a speaker. The method 500 may further comprise, in an operation titled “OBTAINING NOISE SUPPRESSION DATA”, obtaining 520, via a communication channel, noise suppression data from the play-out device, the noise suppression data comprising i) the audio signal, or a reference to the audio signal which enables the audio signal to be accessed, and ii) timing information for enabling the audio signal to be correlated in time with the recorded signal. The method 500 may further comprise, in an operation titled “SYNCHRONIZING AUDIO SIGNAL USING NOISE SUPPRESSION DATA”, synchronizing 530 the audio signal with the recorded signal based on the timing information to obtain a synchronized audio signal. The method 500 may further comprise, in an operation titled “PROCESSING RECORDED SIGNAL USING SYNCHRONIZED AUDIO SIGNAL”, processing the recorded signal based on the synchronized audio signal to obtain a processed signal in which the recording of the sound signal is suppressed.

The operations of the method 500 may be performed in any suitable order. For example, the obtaining 510 of the recorded signal and the obtaining 520 of the noise suppression data may be performed sequentially, or in parallel.

It will be appreciated that a method according to the invention may be implemented in the form of a computer program which comprises instructions for causing a processor system to perform the method. The method may also be implemented in hardware, or as a combination of hardware and software.

The computer program may be stored in a non-transitory manner on a computer readable medium. Said non-transitory storing may comprise providing a series of machine readable physical marks and/or a series of elements having different electrical, e.g., magnetic, or optical properties or values. FIG. 7 shows a computer program product comprising the computer readable medium 600 and the computer program 610 stored thereon. Examples of computer program products include memory devices, optical storage devices, integrated circuits, servers, online software, etc.

It should be noted that the above-mentioned embodiments illustrate rather than limit the invention, and that those skilled in the art will be able to design many alternative embodiments.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A system for noise suppression, comprising:
a play-out device for playing out an audio signal via a speaker to provide a sound signal;
a recording device for recording the sound signal to obtain a recorded signal comprising a recording of at least the sound signal,
wherein:
the play-out device is configured for providing noise suppression data to a communication channel, the noise suppression data comprising:
i) the audio signal, or a reference to the audio signal which enables the audio signal to be accessed; and
ii) timing information for enabling the audio signal to be correlated in time with the recorded signal;
and wherein the system further comprises a noise suppression subsystem configured for obtaining the recorded signal and the noise suppression data, the noise suppression subsystem comprising:
a timing manager for synchronizing the audio signal with the recorded signal based on the timing information to obtain a synchronized audio signal; and
a noise suppressor for processing the recorded signal based on the synchronized audio signal to obtain a processed signal in which the recording of the sound signal is suppressed.

2. The system according to claim 1, wherein the audio signal obtained by the noise suppression subsystem comprises one or more content timestamps, and wherein the timing manager is configured for synchronizing the audio signal with the recorded signal further based on the one or more content timestamps.

3. The system according to claim 2, wherein the audio signal played-out by the play-out device comprises one or more watermarks, the one or more watermarks being associated with one or more watermark timestamps having a known relation in time with the one or more content timestamps, wherein the noise suppression subsystem comprises a watermark detector for detecting the one or more watermarks in the recorded signal, and wherein the timing manager is configured for synchronizing the audio signal with the recorded signal by correlating the one or more watermark timestamps in time with the one or more content timestamps.

4. The system according to claim 3, wherein the one or more watermark timestamps are play-out timestamps of the one or more watermarks at the play-out device, and wherein the timing information provided by the play-out device is constituted at least in part by the one or more play-out timestamps.

5. The system according to claim 3, wherein the one or more watermark timestamps are encoded in respective ones of the one or more watermarks.

6. The system according to claim 1, wherein the play-out device comprises a clock, wherein the timing information provided by the play-out device comprises one or more play-out timestamps associated with one or more content timestamps of the audio signal, wherein the one or more play-out timestamps are derived from the clock during play-out of the audio signal, wherein the recording device comprises a further clock having a known relation in time with the clock of the play-out device, wherein the recording device derives one or more recording timestamps from the further clock during recording of the sound signal, and wherein the timing manager is configured for synchronizing the audio signal with the recorded signal by correlating the one or more recording timestamps in time with the one or more content timestamps of the audio signal using the one or more play-out timestamps.

7. The system according to claim 1, wherein the audio signal obtained by the noise suppression subsystem comprises one or more watermarks matching one or more watermarks in the recorded signal, wherein the noise suppression subsystem comprises a watermark detector for detecting the one or more watermarks in the audio signal and in the recorded signal, and wherein the timing manager is configured for synchronizing the audio signal with the recorded signal by aligning in time the one or more watermarks in the audio signal and in the recorded signal.

8. The system according to any one of claim 1, wherein the recorded signal comprises, in addition to the recording of the sound signal, a recording of a further sound signal, and wherein the noise suppressor processes the recorded signal to obtain the processed signal having the recording of the sound signal suppressed with respect to the recording of the further sound signal.

9. The system according to claim 8, wherein the further sound signal is constituted by speech of a user.

10. A recording device as used in the system according to claim 1, comprising an input interface for receiving the noise suppression data from the play-out device via the communication channel.

11. The recording device according to claim 10, comprising the noise suppression subsystem.

12. A communication system for enabling speech communication between users, comprising at least one instance of the recording device according to claim 10.

13. A play-out device as used in the system according to claim 1, comprising an output interface for providing the noise suppression data to the noise suppression subsystem via the communication channel.

14. The play-out device according to claim 13, comprising at least one of:
a watermark inserter for inserting one or more watermarks in the audio signal prior to play-out and/or transmission via the communication channel; and
a timestamp function unit for determining one or more play-out timestamps during play-out of the audio signal for use in the timing information.

15. Noise suppression data as generated by the play-out device according to claim 13.

16. A method for suppressing noise, comprising:
obtaining a recorded signal comprising a recording of at least a sound signal, the sound signal being provided by a play-out device playing out an audio signal via a speaker;
obtaining, via a communication channel, noise suppression data from the play-out device, the noise suppression data comprising:
i) the audio signal, or a reference to the audio signal which enables the audio signal to be accessed; and
ii) timing information for enabling the audio signal to be correlated in time with the recorded signal;
synchronizing the audio signal with the recorded signal based on the timing information to obtain a synchronized audio signal; and
processing the recorded signal based on the synchronized audio signal to obtain a processed signal in which the recording of the sound signal is suppressed.

17. A computer program product comprising instructions for causing a processing system to perform the method according to claim 16.
